(19) United States
(12) Patent Application Publication
(10) Pub. No.: US 2025/0101249 A1
(43) Pub. Date: Mar. 27, 2025

(54) COMPOSITION FOR A LIQUID SEALING SYSTEM

(71) Applicant: SAINT-GOBAIN WEBER FRANCE, SUCY-EN-BRIE (FR)

(72) Inventors: Coralie TEULERE, AUBERVILLIERS CEDEX (FR); Jérémie LACOMBE, AUBERVILLIERS CEDEX (FR); Icham ROUABAH, AUBERVILLIERS CEDEX (FR)

(21) Appl. No.: 18/729,119

(22) PCT Filed: Jan. 18, 2023
(86) PCT No.: PCT/EP2023/051130

§ 371 Date: Jul. 15, 2024

(30) Foreign Application Priority Data
Jan. 19, 2022 (FR) FR2200459

(51) Int. Cl. C09D 129/14; C08K 3/22; C08K 3/26; C08K 3/34; C08K 5/11; C09D 5/34; C09D 125/14; C09D 175/04; E04B 1/64

(52) U.S. Cl. CPC C09D 129/14; C09D 5/34; C09D 125/14; C09D 175/04; E04B 1/64; C08K 3/22; C08K 2003/2241; C08K 2003/2296; C08K 3/26; C08K 2003/265; C08K 3/34; C08K 5/11

(57) ABSTRACT

A composition for a liquid sealing system, the composition being an aqueous dispersion including: water, 5 to 50% by weight of polyvinyl acetal-based resin particles, a plasticizer, an emulsifier, 5 to 80% by weight of fillers, and 0 to 20% by weight of pigments.

The invention relates to the field of construction. More specifically, it concerns the production of sealing membranes for the building industry.

Waterproofing roofs, terraces, balconies, wet rooms and facades is essential to ensure the longevity of buildings.

Numerous sealing systems have been developed for this purpose. Examples include bituminous membranes and thermoplastic or vulcanized synthetic membranes that are welded together, hot-melt asphalt coatings, or systems known in the trade as “liquid sealing systems” (LSS).

These are made up of polymeric resin-based materials applied in one or more coats by spraying, rolling, brushing or squeegeeing. Various types of resins are used, including polyesters, acrylics, neoprene bitumens and polyurethane resins. Highly durable and easy to apply, these systems generally allow pedestrian traffic directly after drying, eliminating the need for heavy protection.

The aim of the invention is to offer new sealing membranes which are as effective and easy to use as polyurethane resin-based membranes, and which offer better performance, particularly in terms of mechanical properties, water resistance and durability than the acrylic resin-based membranes currently in use. Another aim of the invention is to offer sealing membranes with a lower carbon footprint.

To this end, the invention relates to a composition for a liquid sealing system, said composition being an aqueous dispersion comprising water, 5 to 50% by weight of polyvinyl acetal-based resin particles, a plasticizer, an emulsifier, 5 to 80% by weight of fillers, and 0 to 20% by weight of pigments.

The invention also relates to a method for sealing a roof, terrace, balcony, wet room or facade, comprising applying, to a substrate of said roof, terrace, balcony, wet room or facade, such a composition to form a membrane, then drying said membrane to obtain a dry membrane having a thickness ranging from 0.1 to 2.0 mm.

Another object of the invention is the use of a membrane obtained by applying and drying a composition according to the invention as a waterproofing membrane. It may in particular be applied to a substrate of a roof, terrace, balconie, wet room or facade.

The inventors were able to demonstrate that the formulations claimed had very good mechanical performance, fast drying, very low water absorption and good resistance to ageing.

Preferably, the polyvinyl acetal-based resin is based on polyvinyl butyral, also known as PVB.

Preferably, the resin based on polyvinyl acetal, in particular based on polyvinyl butyral, consists of polyvinyl acetal, in particular polyvinyl butyral.

Preferably, the resin based on polyvinyl acetal, in particular on polyvinyl butyral, includes residual alcohol and acetate functions. These residual functions come from the resin manufacturing method, which generally involves hydrolysis of polyvinyl acetate to polyvinyl alcohol, followed by acetalization thereof. As explained in greater detail later in this text, the presence of alcohol functions enables the resin to be cross-linked and its properties to be improved.

The polyvinyl butyral-based resin is advantageously derived from the recycling of laminated glass. The latter use PVB as a laminating interlayer between two sheets of glass. The use of recycled materials reduces the carbon footprint of the liquid sealing system.

Preferably, the weight content of polyvinyl acetal-based resin, in particular polyvinyl butyral-based resin, in the composition is between 7 and 48%, in particular between 10 and 45%, even between 15 and 40%, and even between 20 and 35%.

The weight content of resin corresponds to the percentage by weight of resin in dry extract in the composition, i.e. the weight of resin in relation to the total weight of the composition. Generally speaking, the contents of the various constituents of the composition are given relative to the total weight of the composition.

The composition may also include particles of other resins, in particular selected from styrene-acrylic resins, styrene-butadiene resins, acrylic resins and mixtures of two or more of these resins. In this case, the ratio between the total weight of these resin particles and the weight of polyvinyl acetal-based resin particles is preferably between 0.05 and 3.0, particularly between 0.1 and 2.0. According to another embodiment, the composition does not comprise particles of resins other than polyvinyl acetal-based resins.

Particles of polyvinyl acetal-based resin (or, where applicable, the other resins described above) preferably have a volume size distribution such that the d50 is between 50 and 300 nm, particularly between 100 and 250 nm. The particle size distribution is in particular determined by dynamic light scattering.

Preferably, the weight ratio between plasticizer content and polyvinyl acetal-based resin content is between 0.1 and 1, particularly between 0.2 and 0.5.

The plasticizer is advantageously chosen from polyethylene glycol esters, adipates, sebacates, phthalates, benzoate esters and mixtures of two or more of these compounds. Examples include tri(ethylene glycol) di(2-ethylhexanoate), tri(ethylene glycol) di(2-ethylbutyrate), tri(ethylene glycol) di(n-heptanoate), tetra(ethylene glycol) di(n-heptanoate), bis(2-butoxyethyl) adipate, dibutyl sebacate, dibutyl phthalate or dioctyl phthalate.

Preferably, the weight ratio between emulsifier content and polyvinyl acetal-based resin content is between 0.001 and 0.05, particularly between 0.005 and 0.025.

The emulsifier is advantageously chosen from ionic (cationic or anionic) emulsifiers and non-ionic emulsifiers. Anionic emulsifiers include in particular carboxylates and sulfonates. Examples of carboxylates are salts of saturated or unsaturated fatty acids such as stearates, oleates and laurates, and rosin salts such as potassium oleate. Sulfonates include alkyl sulfonates, aryl sulfonates, alkyl aryl sulfonates and sulfonated esters such as sodium dodecyl sulfate. Non-ionic emulsifiers include in particular polyoxyethylene alkylphenyl ethers.

The emulsifier is preferably anionic. Such emulsifiers achieve lower water absorption than non-ionic emulsifiers.

The glass transition temperature of the composition is preferably between 5 and 40° C., and in particular between 1° and 30° C., in order to maintain good flexibility after drying, ensuring correct bridging of any cracks that may appear on the substrate. In particular, the glass transition temperature is measured by differential scanning calorimetry. The glass transition temperature can be modified by adjusting the amount of plasticizer.

The minimum film-forming temperature (generally referred to by its acronym “MFFT”) of the composition is preferably less than 30° C., in particular less than 20° C., even less than 10° C. and even less than 0° C., in order to allow film formation and coalescence of the membrane at room temperature under different climatic conditions. The minimum film-forming temperature can be modified by adjusting the amount of plasticizer, or even by adding coalescing agents.

The total weight content of fillers is preferably between 6 and 70%, in particular between 7 and 65%, or between 8 and 50%, or between 9 and 40%, or between 10 and 25%, or between 11 and 24%.

The fillers are preferably mineral in nature. Fillers are preferably selected from calcium carbonate, clays, talc, dolomite, mica, silica sands, ground basalt and mixtures of two or more of these compounds. Preferably, the fillers have a particle size ranging from 0.5 to 500 μm, in particular 1 to 200 μm, measured by laser particle size analysis.

The total weight content of pigments is preferably comprised between 1 and 20%, in particular between 2 and 10%.

The pigments are preferably selected from inorganic pigments (e.g. titanium dioxide or iron oxide), organic pigments (e.g. carbon black), and mixtures of two or more of these compounds.

Preferably, the composition further comprises a cross-linking agent.

The weight ratio between cross-linking agent content and polyvinyl acetal-based resin content is preferably between 0.001 and 0.10, particularly between 0.002 and 0.06.

The cross-linking agent is advantageously selected from water-soluble organometallic compounds, water-insoluble metal oxide or hydroxide particles and organic compounds reactive towards hydroxyl groups.

Organic compounds reactive towards hydroxyl groups include in particular polyfunctional molecules reactive towards hydroxyl groups such as polycarboxylic acids, polyisocyanates and polyaldehydes. Examples include in particular glutaraldehyde and citric acid.

Water-soluble organometallic compounds are preferably zirconium, titanium, zinc or boron complexes. Examples of water-soluble organometallic compounds are diammonium bis[carbonato-O]dihydroxyzirconate, Dihydroxybis(ammonium lactato)titanium(IV), titanium lactate or titanium triethanolamine.

More preferably, the cross-linking agent consists of water-insoluble metal oxide or hydroxide particles, in particular zinc, zirconium or aluminum oxides or hydroxides. Zinc oxides are particularly preferred. These particles are preferably between 0.5 and 100 μm in size, particularly between 1 and 50 μm. Particle size is typically determined by laser granulometry.

The cross-linking agent enables a plurality of resin particles to be cross-linked, in particular thanks to the residual alcohol functions mentioned above. The result is slightly faster drying and, above all, lower water absorption, particularly after immersion in water.

The amount of water in the composition is preferably between 10 and 70% by weight, particularly between 20 and 60% by weight, based on the total weight of the composition.

Preferably, the composition also comprises one or more additives, in particular selected from:
defoaming agents (e.g. silicone, fluorosilicone, mineral oil, acrylic or vinyl polymers),
coalescing agents (e.g. glycols such as propylene glycol or diethylene glycol, glycol ethers such as n-butyl ether dipropylene glycol or propylene glycol methyl ether acetate, ester alcohols such as 2,2,4-trimethyl-1,3-pentanediol monoisobutyrate, pyrrolidones such as N-methyl-2-pyrrolidone or N-butyl-2-pyrrolidone),
rheological agents (e.g. polyurethane/polyurea, polyacrylic, polyamide, castor oil-based, clay-based or cellulose ether),
dispersing agents (e.g. silicone, polyacrylate, polyether),
bactericidal or algicidal agents (particularly isothiazolinone-type agents such as benzisothiazolinone or methylisothiazolinone, or halogenated agents).

The total weight content of these additives is preferably between 0.1 and 10%, preferably between 0.2 and 5%, based on the total weight of the composition.

Dispersing agents are useful to help disperse fillers and pigments. As previously mentioned, coalescing agents can be used to adjust the minimum film-forming temperature.

The composition according to the invention is normally a single-component composition, i.e. it does not require the addition of another composition before or after application.

To seal roofs, terraces, balconies, wet rooms or facades, the composition is applied to a substrate of said roofs, terraces, balconies, wet rooms or facades to form a membrane.

Application is in particular by roller, brush or spray. It can be done in a plurality of layers. In wet rooms, the membrane is usually covered with tiles.

The membrane is then dried. Drying normally takes place naturally in the air, without heating or blowing, and typically lasts from a few minutes to a few hours.

The final membrane may result from applying a plurality of successive layers. Its dry thickness is preferably between 0.1 and 2.0 mm, in particular between 0.2 and 1.5 mm.

The substrate is preferably made of cementitious material (e.g. concrete, mortar or plaster), but can also be made of stone (particularly limestone), brick, terracotta, sandstone or ceramic.

The following non-limiting examples illustrate the invention.

Several dispersions (A to E) comprising resin, plasticizers and emulsifiers were evaluated.

Dispersions A, B and C are PVB-based aqueous dispersions containing triethylene glycol-bis(2-ethylhexanoate) as plasticizer and potassium oleate as emulsifier, marketed by Shark Solutions. Dispersion D is an aqueous polyurethane dispersion, and dispersion E is an aqueous styrene-acrylate dispersion, these dispersions being used in comparative examples.

Table 1 below shows the dry extract percentage, particle size (d50), pH, glass transition temperature (Tg), minimum film-forming temperature (MFFT) and electrostatic charge of the particles at pH 7 for each dispersion.

TABLE 1

| | A | B | C | D | E |
|---|---|---|---|---|---|
| Dry extract (%) | 45.6 | 46.1 | 47.8 | 44.0 | 59.0 |
| Particle size* (nm) | 179 | 194 | 174 | 201 | 142 |
| Tg (° C.) | 24 | 24 | 24 | −75/63 | 11 |
| MFFT (° C.) | <−1 | <−1 | <−1 | <−1 | <−1 |
| Charge (μmol/g) | −75 | −70 | −24 | −252 | −219 |

To these aqueous dispersions were added water, fillers (filler 1: calcium carbonate, filler 2: talc), pigments (titanium dioxide), a cross-linking agent—called a cross-linker—in the form of zinc oxide particles, silicone-type defoaming agents, a polyacrylic-type dispersing agent, a polyurethane-type rheological agent, and a coalescing agent (propylene glycol).

Tables 2 and 3 below show the compositions tested, with contents expressed as a percentage of total composition weight. Examples 1 to 7 are according to the invention, whereas examples C1 and C2 are comparative examples.

TABLE 2

| | 1 | 2 | 3 | 4 | 5 |
|---|---|---|---|---|---|
| Disp. A | 71.2 | 68.4 | — | — | — |
| Disp. B | — | — | 71.2 | 68.8 | — |
| Disp. C | — | — | — | — | 71.2 |
| Water added | 7.8 | 8.6 | 7.8 | 8.3 | 7.8 |
| Defoamer | 0.8 | 0.8 | 0.8 | 0.8 | 0.8 |
| Dispersant | 0.5 | 0.5 | 0.5 | 0.5 | 0.5 |
| Pigments | 3.7 | 4.0 | 3.7 | 4.0 | 3.7 |
| Filler 1 | 11.6 | 12.6 | 11.6 | 12.7 | 11.6 |
| Filler 2 | 2.9 | 3.1 | 2.9 | 3.2 | 2.9 |
| Cross-linker | 0.9 | 1.0 | 0.9 | 1.0 | 0.9 |
| Rheological | 0.3 | 0.6 | 0.5 | 0.4 | 0.5 |
| agent | | | | | |
| Coalescing | 0.3 | 0.3 | 0.3 | 0.2 | 0.3 |
| agent | | | | | |
| Resin content | 24.7 | 23.7 | 24.1 | 24.9 | 25.9 |
| Plasticizer | 7.5 | 7.2 | 7.3 | 7.5 | 7.8 |
| content | | | | | |
| Dry extract | 53.6 | 54.1 | 53.8 | 54.6 | 55.2 |

TABLE 3

| | 6 | 7 | C1 | C2 |
|---|---|---|---|---|
| Disp. A | 71.5 | — | — | — |
| Disp. B | — | 71.5 | — | — |
| Disp. D | — | — | 71.8 | — |
| Disp. E | — | — | — | 71.8 |
| Water added | 7.8 | 7.8 | 7.4 | 7.4 |
| Defoamer | 0.8 | 0.8 | 0.8 | 0.8 |
| Dispersant | 0.5 | 0.5 | 0.5 | 0.5 |
| Pigments | 3.8 | 3.8 | 3.7 | 3.7 |
| Filler 1 | 12.0 | 12.0 | 11.6 | 11.6 |
| Filler 2 | 3.0 | 3.0 | 2.9 | 3.2 |
| Cross-linker | — | — | 0.9 | 0.9 |
| Rheological agent | 0.4 | 0.4 | 0.3 | 0.3 |
| Coalescing agent | 0.2 | 0.2 | 0.1 | 0.1 |
| Resin content | 24.8 | 25.1 | 31.6 | 42.4 |
| Plasticizer content | 7.5 | 7.6 | 0 | 0 |
| Dry extract | 51.8 | 52.2 | 52.4 | 63.2 |

Membranes of 0.3 to 0.4 mm dry thickness were then obtained after applying a 1 mm wet film and drying for 7 days at 23° C. and 50% relative humidity.

Tables 4 and 5 below show, for each example, the drying time of a 1 mm-thick wet film (determined using a device known as a “BK drying recorder”), tensile strength (in MPa) and elongation at break (in %) (determined using a tensile tester at a speed of 50 mm/min at 23° C. and 60° C.), water absorption after 1 and 7 days (in %) and mass loss after 7 days in water.

The water absorption A after 1 or 7 days is calculated from the mass M1 of the film after 1 or 7 days of immersion in water and the mass M2 of the film immersed in water for 1 or 7 days and then dried at 50° C. for 10 hours, according to the following formula: A=100*(M1−M2)/M2.

Tensile strength and elongation were also measured after immersion in water for 7 days, and after ageing under UV light (7 days at 110 W/m²). Tackiness after treatment at 60° C. was also assessed qualitatively.

TABLE 4

| | 1 | 2 | 3 | 4 | 5 |
|---|---|---|---|---|---|
| Drying (min) | 100 | 100 | 100 | 95 | 100 |
| Tensile strength 23° C. | 9.9 | 10.1 | 10.0 | 8.7 | 11.0 |
| (MPa) | | | | | |
| Elongation 23° C. (%) | 450 | 520 | 480 | 490 | 390 |
| Absorption 1 day (%) | 12.2 | 14.9 | 13.9 | 14.2 | 27.5 |
| Absorption 7 days (%) | 7.7 | 10.0 | 9.0 | 8.5 | 23.2 |
| Mass loss (%) | 4.1 | 4.3 | 3.6 | 4.5 | 2.0 |
| Tensile strength 60° C. | 3.0 | 3.5 | 3.4 | 3.7 | — |
| (MPa) | | | | | |
| Elongation 60° C. (%) | >1300 | 1210 | >1300 | >1300 | — |
| Tackiness 60° C. | no | no | no | no | no |
| Tensile strength after | 5.8 | 5.3 | 5.5 | 5.3 | 3.5 |
| immersion (MPa) | | | | | |
| Elongation after | 710 | 710 | 700 | 700 | 740 |
| immersion (%) | | | | | |
| Tensile strength after UV | 13.6 | 12.0 | 12.9 | 12.7 | 11.2 |
| (MPa) | | | | | |
| Elongation after UV (%) | 460 | 410 | 420 | 430 | 290 |

TABLE 5

| | 6 | 7 | C1 | C2 |
|---|---|---|---|---|
| Drying (min) | 110 | 120 | 100 | 110 |
| Tensile strength 23° C. (MPa) | 11.2 | 9.8 | 8.1 | 2.7 |
| Elongation 23° C. (%) | 560 | 570 | 1500 | 750 |
| Absorption 1 day (%) | 20.9 | 18.7 | 11.0 | 11.7 |
| Absorption 7 days (%) | 11.9 | 12.0 | 15.3 | 25.8 |
| Mass loss (%) | 4.7 | 4.2 | 2.9 | 2.0 |
| Tackiness 60° C. | no | no | no | yes |
| Tensile strength after immersion (MPa) | 3.1 | 3.8 | 5.3 | 0.6 |
| Elongation after immersion (%) | 600 | 620 | 1680 | 1330 |
| Tensile strength after UV (MPa) | — | — | 4.8 | 3.0 |
| Elongation after UV (%) | — | — | 840 | 690 |

It can be deduced from these various results that membranes according to the invention are generally better than styrene-acrylic resin-based membranes, particularly in terms of water absorption. Membranes according to the invention also offer mechanical performance similar to that of polyurethane-based membranes, and in some cases better performance in terms of water absorption, even at low resin levels.

The addition of a cross-linking agent reduces drying time, and most importantly, water absorption. Elongation is slightly reduced but remains acceptable for the targeted applications. The cross-linking agent also improves mechanical performance (tensile strength and elongation) after immersion in water.

Membranes according to the invention are particularly resistant to ageing, and in particular have very good mechanical properties after UV irradiation. At high temperatures, membranes according to the invention retain good mechanical properties, and do not become tacky, unlike styrene-acrylic-based membranes.

1. A composition for a liquid sealing system, said composition being an aqueous dispersion comprising: water, 5 to 50% by weight of polyvinyl acetal-based resin particles, a plasticizer, an emulsifier, 5 to 80% by weight of fillers, and 0 to 20% by weight of pigments.

2. The composition according to claim 1, wherein the polyvinyl acetal-based resin is polyvinyl butyral-based.

3. The composition according to claim 2, wherein the polyvinyl butyral-based resin comprises residual alcohol and acetate functions.

4. The composition according to claim 3, wherein the polyvinyl butyral-based resin is derived from the recycling of laminated glass.

5. The composition according to claim 1, further comprising a cross-linking agent.

6. The composition according to claim 5, wherein a weight ratio between the cross-linking agent content and the polyvinyl acetal-based resin content is between 0.001 and 0.10.

7. The composition according to claim 5, wherein the cross-linking agent is chosen from water-soluble organometallic compounds, water-insoluble metal oxide or hydroxide particles and organic compounds reactive towards hydroxyl groups.

8. The composition according to claim 1, wherein a weight ratio between the plasticizer content and the polyvinyl acetal-based resin content is between 0.1 and 1.

9. The composition according to claim 1, wherein a weight ratio between the emulsifier content and the polyvinyl acetal-based resin content is between 0.001 and 0.05.

10. The composition according to claim 1, further comprising particles of other resins.

11. The composition according to claim 1, wherein the fillers are chosen from calcium carbonate, clays, talc, dolomite, mica, silica sands, ground basalt and mixtures of two or more of these compounds.

12. The composition according to claim 1, wherein an amount of water is between 10 and 70% by weight.

13. A method for sealing a roof, terrace, balcony, wet room or facade, comprising applying, to a substrate of said roof, terrace, balcony, wet room or facade, a composition according to claim 1 to form a membrane, then drying said membrane to obtain a dry membrane having a thickness ranging from 0.1 to 2.0 mm.

14. The method according to claim 13, wherein the substrate is made of cementitious material.

15. A method comprising providing a membrane obtained by applying and drying a composition according to claim 1 as a waterproofing membrane.

16. The composition according to claim 6, wherein the weight ratio between the cross-linking agent content and the polyvinyl acetal-based resin content is between 0.002 and 0.06.

17. The composition according to claim 8, wherein the weight ratio between the plasticizer content and the polyvinyl acetal-based resin content is between 0.2 and 0.5.

18. The composition according to claim 9, wherein the weight ratio between the emulsifier content and the polyvinyl acetal-based resin content is between 0.005 and 0.025.

19. The composition according to claim 10, wherein the other resins are selected from styrene-acrylic resins, styrene-butadiene resins, acrylic resins and mixtures of two or more of these resins.

20. The composition according to claim 12, wherein the amount of water is between 20 and 60% by weight.
